(19) United States
(12) Patent Application Publication
(10) Pub. No.: US 2010/0326957 A1
(43) Pub. Date: Dec. 30, 2010

(54) PLASMA PROCESSING APPARATUS AND PLASMA PROCESSING METHOD

(76) Inventors: Kenji Maeda, Koganei (JP); Kenetsu Yokogawa, Tsurugashima (JP); Tomoyuki Tamura, Kudamatsu (JP); Kazuyuki Hirozane, Kudamatsu (JP); Takamasa Ichino, Kudamatsu (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/538,201

(22) Filed: Aug. 10, 2009

(30) Foreign Application Priority Data
Jun. 24, 2009 (JP) 2009-149772

(51) Int. Cl. B44C 1/22; C23F 1/08

(52) U.S. Cl. 216/67; 156/345.26

(57) ABSTRACT

An electrostatic adsorption layer, an electrode layer, and an insulating layer are provided in a lower portion of a focus ring disposed in an outer periphery of a substrate stage. A high frequency bias is applied to the focus ring by applying a high frequency electric power to the electrode layer. Further, the focus ring is electrostatically chucked to the electrostatic chucking layer and a heat transfer gas is provided between the focus ring and the electrostatic adsorption layer. Thus, the focus ring can be cooled and the temperature of the focus ring is controlled to a predetermined value. With this structure, an etching characteristic at a wafer edge portion can be maintained favorably for a long time. Also, a yield rate at the edge portion can be favorably maintained for a long time, a wet period can be prolonged, and the device operation rate can be improved.

### BACKGROUND OF THE INVENTION

1. Field of the Invention

The present invention relates to a dry etching apparatus (plasma processing apparatus) and an etching method for etching an insulating film. For example, it relates to a plasma processing apparatus and a plasma processing method which can, in particular, suppress degradation of etching characteristics such as slanting (tilting) of a hole taking place at a wafer edge, mask clogging, and reduction of etching selectivity when a pattern of a sample to be processed is a high aspect-ratio contact hole.

2. Description of the Related Art

With respect to a memory device represented by DRAM (Dynamic Random Access Memory), as integration progresses, it becomes important to maintain capacity of a capacitor. When roughly classifying capacitor structures, there are a trench capacitor in which a deep trench is formed in a silicon substrate, and a stack capacitor in which a capacitor is formed in an upper portion of a transistor. In order to increase capacity of each of the capacitors, it is necessary to secure a sufficient height of the capacitor or to make a dielectric film thinner. However, increasing the height of the capacitor depends on an etching performance. On the other hand, to make the dielectric film thinner has reached a threshold in a silicon oxide film, and is dependent on development of high dielectric materials. In order to reduce etching load, an effort has been made to secure a capacitor capacity, also in a low aspect pattern, by using both sides of the pattern as electrodes. However, because of miniaturization of parts, it became difficult to secure a mechanical strength at the bottom of the pattern alone, causing a problem of adjacent capacitors to be in contact with each other.

Therefore, it is conceivable that a structure using an inner side of a pattern as a capacitor will mainly be used, and is conceivable that processing at a high aspect ratio will be continued. According to International Semiconductor Technology Roadmap, the aspect ratio will be as high as about 50 in 2011. It will be required that, with a large-diameter wafer of 300 mm or more, a portion of the wafer 3 mm from its edge should be processed uniformly. Probably, in the future, it will be desired that the value of 3 mm from the wafer edge will gradually be reduced and, as an ultimate demand, it will be necessary that an excellent product of 0 mm from the wafer edge should be taken.

Next, a method of dry etching will be described. The dry etching is a technique performed as follows. First, an etching gas introduced into a vacuum vessel is turned into plasma by a high-frequency electric power applied from the outside. Then, reactant free radicals and ions generated in the plasma are irradiated to a wafer. Further, with respect to mask materials represented by a resist, a wiring layer under a via, a contact hole, a capacitor, etc. or a ground substrate, etching is selectively applied to a film (insulating film) to be processed. In forming the via, contact hole, and the capacitor previously described, as the etching gas, gases are used by mixing rare gasses represented by Ar or Xe and a gaseous oxygen etc. into fluorocarbon gases such as CF₄, CHF₃, C₂F₆, C₂F₄, C₃F₆O, C₄F₈, C₅F₈, C₄F₆, C₅F₆, and C₆F₆.

Moreover, when a high-frequency bias is applied to the wafer, the positive spatial charge layer called an ion sheath is formed in the upper portion of the wafer, and a positive ion generated in the plasma is accelerated by a sheath voltage and enters the wafer. By controlling an electrode bias (bias voltage), ion energy can be controlled from about 0.5 kV to 5 kV, realizing a minute and perpendicularly processed form. In this regard, although it is necessary to realize a uniform processing in a wafer plane, irregularity in form at the wafer edge may take place in reality. Hereafter, this problem will be explained with reference to FIGS. 9 to 12.

FIG. 9 schematically shows a state of a wafer edge portion under etching. Moreover, FIG. 10 shows an etching form near the wafer edge. Provided in an outer periphery of the wafer 4 is a silicon focus ring 51 which is an almost circular ring-shaped member. The above high-frequency bias is also applied to the focus ring. The dashed line of FIG. 9 shows a state of a plasma/sheath interface when a surface of the focus ring and a wafer surface generally match. Also, an arrow in FIG. 9 shows a direction in which ions are accelerated in the sheath.

Here, high-frequency bias power value applied per unit area to the wafer 4 is the same as that to the focus ring 51. In that case, as shown by the dashed line, the position of the plasma/sheath interface on the wafer matches that of the plasma/sheath interface on the focus ring. Therefore, as shown by an arrow of FIG. 10, ions enter perpendicularly to the edge of the wafer 4. As a result, as shown in FIG. 10, the form of the hole is such that it is processed perpendicularly to the wafer edge.

However, as the number of wafers to be processed increases, the focus ring 51 itself also is shaved (worn) by the action of reactant free radicals or ion incidence. In this case, as shown in FIG. 11, for example, it is conceivable that the surface of the focus ring 51 is located lower than the surface of the wafer 4. Also, in this regard, assuming that the value of the high-frequency bias per unit area applied to the focus ring 51 is the same as that of the wafer 4, as shown in FIG. 11, the thickness of the ion sheath formed on the wafer and the thickness of the ion sheath formed on the focus ring become the same. Therefore, the plasma/sheath interface on the focus ring shifts downward as much as the focus ring is worn.

As a result, the ion sheath near the wafer edge is distorted, and ions in this portion enter toward the center side of the wafer in a slanting manner. FIG. 12 shows a form of the processed hole near the wafer edge at that time. It is seen that, near the wafer edge at which ions enter the wafer in a slanting manner, the form of the hole is gradually slanting (this phenomenon is hereafter called “tilting”). Thereby, an yield rate at the wafer edge falls. Replacing a focus ring frequently to prevent the fall in the yield rate brings about a decline in the device operating ratio and a rise in running cost.

On the other hand, it is proposed to vary an electrode-bias ratio for the focus ring with respect to the high-frequency electrode bias applied to the wafer (see Patent Document 1, for example). This technique is such that part of the high-frequency bias power applied to the wafer is also applied to the focus ring using an electric power allocation means.

The thickness of the sheath formed on the wafer or on the focus ring gets thicker as the bias becomes higher. That is, the plasma/sheath interface on the wafer/focus ring boundary can be maintained uniformly for a long time by raising, as the focus ring is worn, an electrode-bias ratio to be applied to the focus ring. As a result, tilting can be suppressed over a long period of time.

On the other hand, generally, in an etching apparatus, a control in which a wafer bias power is kept constant is performed. In other words, the control in which the sum of the electric power allocated to the focus ring side and the electric power allocated to the wafer side is kept constant is performed. Therefore, according to the technique disclosed in Patent Document 1, when the ratio of the electric power allocated to the focus ring changes, the electric power allocated to the wafer side also changes, causing the etching characteristic itself to change. In order to avoid this problem, the present applicant has submitted a prior application as Patent Application No. 2009-29252 in which the control is performed such that the electric power allocated to the wafer side is kept constant. Moreover, in order to obtain a desired etching characteristic, a surface temperature of the wafer to be processed is controlled. A technique to control the temperature is disclosed in Patent Document 2. (Patent Document 1) Japanese Patent Laid-open No. 2005-203489 (Patent Document 2) Japanese Patent Laid-open No. 2007-258500

### SUMMARY OF THE INVENTION

With use of the technique disclosed in Patent Document 1 and the prior application by the present applicant, tilting at the wafer edge can be suppressed over a long time period. However, another problem as follows arises.

Generally, in order to obtain a desired etching characteristic, the surface temperature of the wafer to be processed is controlled to be somewhere between about 30° C. and 120° C. On the other hand, the focus ring is a consumable part. Therefore, it is often structured to be easily detached from and attached to a substrate stage. Therefore, in a vacuum atmosphere, the focus ring floats thermally. Therefore, in insulating-film etching using high wafer bias conditions, the heat of the focus ring cannot escape, raising the temperature to a level between 600° C. and 800° C. According to Stefan-Boltzmann law, the energy by radiation is proportional to the 4th power of an absolute temperature. Therefore, the temperature of the wafer edge portion is strongly influenced by the radiant heat from the focus ring.

Moreover, as described above, in order to suppress the tilting, when the electrode-bias ratio to be applied to the focus ring is raised as the focus ring is worn, the temperature of the focus ring also rises accordingly. Therefore, the temperature of the wafer edge portion is also raised by the radiation.

In this way, when the temperature of the wafer edge portion rises, there occur fatal problems to the etching characteristics such as an occurrence of etching stop in the wafer edge portion, an occurrence mask clogging, and a fall in the mask selectivity. Further, a yield rate at the edge portion may remarkably fall, and a favorable etching characteristic may not be maintained at the wafer edge portion over a long period of time.

As shown in Patent Document 2, a technique to cool the focus ring is also disclosed. However, degradation of the etching characteristic at the wafer edge portion accompanying the wearing of the focus ring cannot be suppressed simply by cooling the focus ring and controlling the bias power to be allocated to the focus ring. For, even if the temperature of the focus ring is controlled by cooling the focus ring, it is difficult to control the temperature change of the focus ring over a long period of time.

In view of the problems of the above conventional techniques, an object of the present invention is to provide a plasma processing apparatus and a plasma processing method for satisfying the two contradictory demands of suppression of tilting due to wearing of the focus ring and prevention of degradation of the etching characteristic due to rise in temperature of the focus ring.

In order to achieve the above objects, according to the present invention, a plasma processing apparatus comprises: a vacuum vessel evacuated by vacuum evacuation means; gas supply means for supplying a gas to the vacuum vessel; a high frequency power supply for generating plasma; a substrate stage for loading a substrate to be processed and a focus ring disposed in the outer periphery of the substrate; a high frequency bias power supply for supplying a high frequency bias electric power to the substrate stage; and electric power allocation means for allocating and applying part of the high frequency bias electric power outputted from the high frequency bias power supply to the focus ring, wherein there are formed in said substrate stage a heat transfer gas groove for introducing a heat transfer gas into a backside surface of the focus ring and a coolant groove for allowing a coolant to flow thereunder; and wherein there are provided a storage medium for holding an application time of the high frequency bias electric power applied to said focus ring and control means for controlling, according to the stored application time, the electric power allocation means so as to change allocation of the high frequency electric power to the focus ring and, at the same time, controlling at least one of a pressure of said heat transfer gas and a temperature of said coolant; and wherein temperature of the coolant.

Further, in the above plasma processing apparatus, an electrostatic chucking layer is formed integrally with an electrode layer and an insulating layer in a lower portion of the focus ring; and the heat transfer gas groove is formed between the electrostatic chucking layer and the focus ring.

Still further, in the above plasma processing apparatus, there are provided an electrode ring in the lower portion of the focus ring and an insulating ring in a lower portion thereof, wherein an electrostatic chucking layer is formed on an upper surface of the insulating ring by flame spraying; and wherein heat transfer gases are provided between an undersurface of the focus ring and an upper surface of the electrostatic chucking layer, between an undersurface of the electrode ring and the upper surface of the insulating ring, and between an undersurface of the insulating ring and an upper surface of the outer periphery of a base material of the substrate stage, respectively.

Still further, in the above plasma processing apparatus, the control means controls the pressure of the heat transfer gas according to the electric power allocated to the focus ring.

Still further, in the above plasma processing apparatus, the control means controls the temperature of a coolant to be allowed to flow in a lower portion of the focus ring according to the electric power allocated to the focus ring.

Still further, in the above plasma processing apparatus, the control means controls the pressure of the heat transfer gas and the temperature of a coolant to be allowed to flow in the lower portion of the focus ring according to the electric power allocated to the focus ring.

Still further, according to the present invention, there is provided a plasma processing method for processing, through the effect of plasma, a substrate to be processed placed on a substrate stage by supplying a gas to a vacuum vessel, wherein a high frequency bias power supply applies, to the substrate stage, a predetermined high frequency bias electric power being different from a high frequency electric power supply for generating plasma; wherein electric power allocation means allocates and applies a high frequency bias electric power outputted from the high frequency bias power supply to a focus ring disposed in the periphery of the substrate to be processed; wherein, according to an application time of the high frequency bias electric power to the focus ring by the plasma processing, the high frequency bias electric power to be applied to the focus ring is varied by controlling the electric power allocation means; wherein the high frequency bias electric power to be applied to the substrate stage is controlled by controlling output of the high frequency bias power supply; and wherein the temperature of the focus ring is controlled to be a predetermined temperature according to the high frequency bias electric power applied to the focus ring.

According to the present invention, when the focus ring is worn as the plasma processing advances, even if the bias voltage to be applied to the focus ring is raised to suppress tilting at the wafer edge portion, degradation of the etching characteristic can be prevented because the temperature of the focus ring is controlled.

Further, the temperature of the focus ring can be controlled in a delicate manner over a long period of time by controlling the pressure of the heat transfer gas and the coolant temperature of the outer periphery of the lower electrode according to the high frequency electric power to be allocated to the focus ring.

### BRIEF DESCRIPTION OF THE DRAWINGS

FIG. 1 is a longitudinal cross section of a plasma processing apparatus being a first embodiment of the present invention;

FIG. 2 is a longitudinal cross section of an outer periphery of a substrate stage according to the present invention;

FIG. 3 is a plan view showing one example of an electrode pattern and a pattern of a heat transfer gas hole provided below the focus ring;

FIG. 4 is a longitudinal cross section showing a feeding part to an electrode layer provided below the focus ring;

FIG. 5 is a graph showing the temperature of a focus ring of a prior art;

FIG. 6 is a graph showing a sequence diagram and the temperature of a focus ring according to the present invention;

FIG. 7 is a flowchart of the control according to the present invention;

FIG. 8 is a longitudinal cross section of the outer periphery of a substrate stage according to a second embodiment of the present invention;

FIG. 9 is a schematic diagram explaining normal hole processing;

FIG. 10 is a schematic diagram explaining normal hole processing;

FIG. 11 is a schematic diagram explaining the tilting in the hole processing; and

FIG. 12 is a schematic diagram explaining the tilting in the hole processing.

### DESCRIPTION OF THE PREFERRED EMBODIMENTS

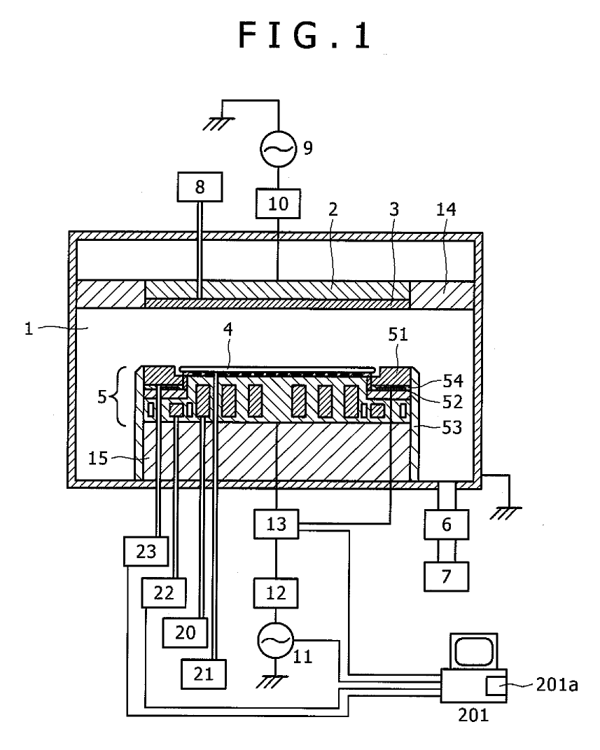

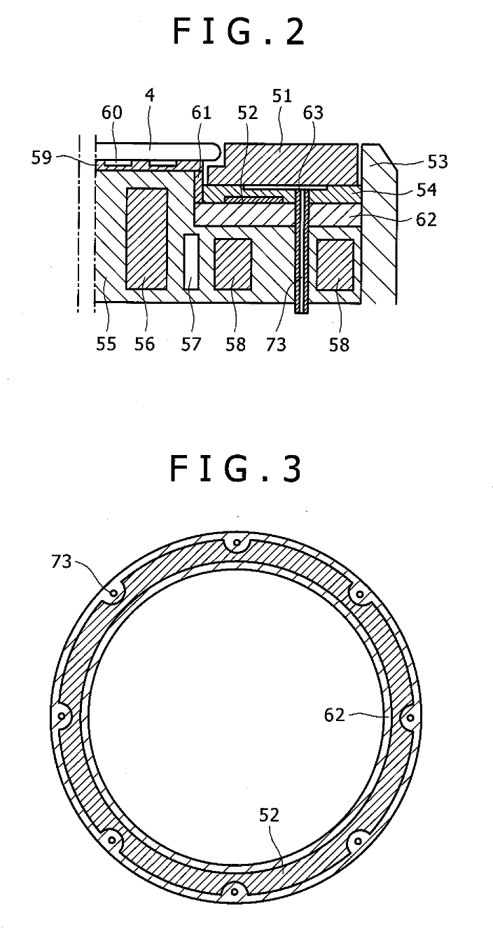

Now, with reference to FIGS. 1 to 7, a first embodiment of the present invention will be described. FIG. 1 is a longitudinal cross section of a plasma processing apparatus according to the present embodiment, FIG. 2 is a longitudinal cross section of the outer periphery of the substrate stage according to the present embodiment, FIG. 3 is a plan view showing one example of an electrode pattern and a pattern of a heat transfer gas hole provided below the focus ring, and FIG. 4 is a longitudinal cross section showing a feeding part to an electrode layer provided below the focus ring.

In FIG. 1, according to the plasma processing apparatus of the present embodiment, there are provided, in a vacuum vessel 1, an upper electrode 2, a shower plate 3, an insulating members 14 and 15, and a substrate stage 5 for loading a disc-like wafer to be processed (substrate to be processed) 4. On the substrate stage, there is provided an almost circular ring-shaped member (focus ring) 51 in the outer periphery of the wafer 4 to be processed. Further, the substrate stage 5 also serves as a lower electrode for supplying a bias high frequency electric power to the wafer 4 to be processed.

Furthermore, in the vacuum vessel 1, there are provided a conductance regulation bulb 6 and a vacuum evacuating system 7. Etching gas is adjusted by the gas supply system 8 to a desired flow rate and is introduced into the vacuum vessel 1 through the shower plate 3. The pressure under plasma processing can be adjusted to a desired pressure from about 0.2 Pa to 20 Pa by the previously described conductance adjustment bulb 6.

To the upper electrode 3, a high frequency power supply 9 for generating plasma is connected through a first impedance matching unit 10 and supplies a high frequency electric power for generating plasma to the vacuum vessel 1. A gas of a desired flow rate is introduced into the vacuum vessel 1. After controlling the pressure to a desired level, the electric power is supplied from the high frequency power supply 9 for generating plasma so that plasma is generated in the upper portion of the wafer 4 to be processed.

To the substrate stage 5, a high frequency bias power supply 11 is connected through electric power allocation means 13 and a second impedance matching unit 12. A fine pattern can be perpendicularly processed by pulling ions in the plasma into the substrate 4 through application of a wafer bias to the substrate 4 with the plasma being generated in the upper portion of the substrate (wafer) 4 to be processed. The electric power allocation means 13 allocates, at a desired ratio, the high frequency electric power supplied from the bias power supply 11 to the wafer 4 and the almost circular ring-shaped focus ring 51 provided in the outer periphery of the wafer 4, and comprises a capacitor of variable capacity. Moreover, in the outermost periphery of the substrate stage 5, a susceptor 53 made of fine ceramics, such as quartz or high purity alumina ceramics, is disposed. As a result, when a bias is applied, a sidewall etc. of the substrate stage 5 are prevented from being worn due to ion bombardment.

Numeral 201 represents control means, which has a built-in storage means 201a for holding an application time of the high frequency bias electric power to the focus ring 51. The control means 201 controls the output of the bias power supply 11 according to the stored application time. Also, the control means 201 controls the allocation ratio of the electric power of the electric power allocation means 13.

Not only applying the bias to the wafer 4, the substrate stage 5 electrically chucks the wafer 4 onto the stage 5, and also has a function of controlling the temperature of the wafer. Hereafter, mainly with reference to FIG. 2, a structure of the substrate stage 5 will be explained in detail.

The substrate stage 5 is structured such that a coolant groove 56 is provided coaxially in the inner circumference of the conductive stage base material 55 of aluminum or titanium etc. In the upper portion thereof, a first electrostatic chucking layer 59 having a thickness about 20 μm to 2000 μm is integrally formed. The temperature controller 20 (FIG. 1) is connected to the coolant groove 56. The temperature of the inner circumferential part of the stage base material 55 and the first electrostatic chucking layer 59 can be adjusted to desired levels by allowing the coolant adjusted to a desired temperature to circulate. Moreover, a direct-current power supply (not shown) is connected to the stage base material 55, and the electrostatic chucking of the wafer 4 to be processed can be performed by applying a voltage of several ten volts to several kilovolts. The electrostatic chucking film 59 may be formed by flame spraying alumina, alumina/titania, yttria, etc. Alternatively, a sintered body, such as of alumina or aluminum nitride etc. maybe joined to the stage base material 55 by means such as adhesives and brazing.

Plasma processing is performed under reduced pressure of about 0.2 Pa to 20 Pa. Therefore, the temperature of the wafer itself can hardly be controlled simply by mounting the wafer on the substrate stage and performing the electrostatic chucking of the wafer. Therefore, the heat transfer rate between the wafer and the electrostatic chucking layer 59 is promoted with use of a first heat transmission gas introduction mechanism 21 (FIG. 1) by introducing the heat transfer gas such as helium to the rear surface of the wafer at a pressure of about 0.5 kPa to 5 kPa. In order to distribute the heat transfer gas uniformly on the rear surface of the wafer, there is provided on the upper surface of the first electrostatic chucking layer 59 a gas groove 60 of about 20 μm to 200 μm deep.

Furthermore, on the upper surface of the outer periphery of the substrate stage 5, there is provided a focus ring 51 of Si or SiC such that it surrounds the outer circumference of the wafer 4 to be processed. Since focus ring 51 is a consumable part, it can easily be detached from and attached to the substrate stage 5. Under the focus ring 51, there is provided an electrode layer 52 through a second electrostatic chucking layer 54, and part of the high frequency electric power supplied as a wafer bias by the electric power allocation means (FIG. 1) is supplied here. The high frequency electric power supplied to the electrode layer 52 is applied to the focus ring 51 through the electrostatic chucking layer 54.

A first insulating layer 62 is provided between the second electrostatic chucking layer 54 as well as the electrode layer 52 and the outer periphery of the stage base material 55. Moreover, a second insulating layer 61 is provided between the focus ring 51 as well as the electrostatic chucking layer 54 and the base material 55. Also, while the focus ring is easily detached and attached, the above second electrostatic chucking layer 54, the electrode layer 52, and the first insulating layer 62 are all joined and integrally formed. The purpose of forming these members integrally is not to allow the vacuum insulating layer to be between the members, to improve transfer rate of the heat, and not to prevent the heat transfer.

A direct-current power supply (not shown) is connected to the electrode layer 52, enabling the electrostatic chucking of the focus ring 51. A heat transfer gas groove 63 is provided in the upper portion of the electrostatic chucking layer 54. The heat transfer gas, such as helium, can be introduced to the rear surface of the focus ring 51 from the heat transfer gas introduction mechanism 23 (FIG. 1) through about three to thirty gas introduction tubes 73 of alumina. Thus, the heat transfer rate between the focus ring 51 and the electrostatic chucking layer 54 can be promoted. In addition, a minor temperature control of the focus ring 51 can be performed through the heat transfer gas introduction mechanism 23 when the pressure of the heat transfer gas is controlled by the control means 201 to control the heat transfer rate of the gas in the heat transfer gas groove 63.

FIG. 3 shows an example of a layout of the first insulating layer 62, the electrode layer 52, and an insulating pipe 73 in a plane. In this example, the gas introduction tubes are arranged such that it bypasses the electrode layer 52 by being positioned at eight spots at generally regular intervals in a circumferential direction 8. The purpose of providing a plurality of gas introduction tubes is to eliminate the pressure difference in the circumferential direction of the heat transfer gas to be introduced into the lower portion of the focus ring 51. Further, by disposing the gas introduction tubes 73 to bypass the electrode layer 52, the possibility of unusual electric discharge in the tubes can be lowered. Also, though not shown, by providing porous ceramics at the tip of the gas introduction tube, the risk of unusual electric discharge can be further reduced. Alternatively, the risk of the unusual electric discharge can further be reduced by allowing the gas introduction tube to be structured such that its diameter is about 3 mm to 15 mm and several to tens of minute holes whose diameters are 0.1 mm to 0.5 mm are provided inside.

The explanation will be continued with reference to FIG. 2 again. A second coolant groove 58 is provided below the focus ring 51, second electrostatic chucking layer 54, electrode layer 52, and first insulating layer 62 and, at the same time, in the outer periphery of the stage base material 55. To the second coolant groove 58, a second temperature controller 22 (FIG. 1) is connected, and by allowing the coolant adjusted at a desired temperature to flow, the temperature of the outer periphery of the stage base material 55 can be controlled. The heat entering from the plasma to the focus ring 51 can be efficiently discharged to the outer periphery of the stage base material 55 through the focus ring 51, the electrostatic chucking layer 54, the electrode layer 52, and the first insulating layer 62. Therefore, the focus ring can be cooled efficiently. In the temperature controller 22, the temperature of the coolant is controlled by the control means 201, and the temperature controller 22 is suited for controlling the temperature of the stage base material 55 having a large outer periphery.

Moreover, there were two coolant grooves 56 and 58 provided. Therefore, it is possible to separately control the temperature of the wafer 4 to be processed and the temperature of the focus ring 51. As a result, it is possible to perform plasma processing on a thermally optimum etching condition. Furthermore, by providing a vacuum thermal insulating layer 57 between the first coolant groove 56 and the second coolant groove 58, independent controllability of the temperature can be further improved. If the vacuum thermal insulating layer 57 is omitted, the independent controllability of temperature will be slightly spoiled. Needless to say, however, the cost can be reduced as much.

The first insulating layer 62 and the second insulating layer 61 serve to reduce the high frequency coupling between the base material 55 and the electrode layer 52, the electrostatic adsorption layer 54 as well as the focus ring 51. Preferable materials for the insulating layer include aluminum nitride (AlN), alumina (Al203), etc. having high withstand voltages and comparatively high heat transfer rates which do not cause contamination. The thickness of these insulating layers is suitably chosen from 200 μm to 30 mm. When the thickness of the insulating layer is 200 μm or less, the high frequency coupling between the base material 55 and the electrode layer 52, the electrostatic chucking layer 54 as well as the focus ring 51 becomes strong, so that controllability of the high frequency bias electric power allocated to the focus ring 51 is deteriorated. On the other hand, when the thickness of the first insulating layer 62 is 30 mm or over, the thermal resistance in the first insulating layer 62 gets too large, so that it becomes difficult to allow the heat entering from the plasma to the focus ring 51 to escape to the stage base material 55. That is, it becomes difficult to cool the focus ring or to control its temperature.

As described so far, a feature of the present invention is to form the first insulating layer 62, electrode layer 52, and the electrostatic adsorption layer 54 integrally with the stage base material 55. Another feature is to electrostatically chuck the focus ring 51 during plasma processing and to provide a heat transfer gas such as helium between the focus ring 51 and the electrostatic chucking layer 54. With this structure, even under a reduced pressure of about 0.2 Pa to 20 Pa, the focus ring 51 can be efficiently cooled and its temperature can be efficiently controlled.

Now, one example of the procedure to form the insulating layer 62, the electrode layer 52, and the electrostatic adsorption layer 54 integrally with the stage base material will be explained.

First of all, a first insulating layer 62 is formed in the outer periphery of the base material 55. The first insulating layer 61 is an about 10 mm thick almost circular ring-shaped sintered body of AlN, and is joined to the stage base material with means such as adhesives or brazing etc. Next, a second insulating layer 62 of about 1000 μm thick is formed on the sidewall of the upper portion of the stage base material 55 by flame spraying alumina etc. Then, the electrode layer 52 is formed by flame spraying tungsten onto the upper portion of the first insulating layer 62. The thickness of the electrode layer 52 is about 20 μm to 500 μm. This value is suitably determined by electrical resistance of tungsten. Next, the electrostatic chucking layer 54 is formed by flame spraying alumina or alumina/titania mixture being 50 μm to 1000 μm thick, onto the electrode layer 52 and the upper portion of the first insulating layer 62. Finally, in the upper portion of the electrostatic chucking layer 54, a heat transfer gas groove 63 of about 20 μm to 200 μm deep is formed by grinding or blast treatment.

The process of forming the insulating layer, electrode layer, and electrostatic chucking layer integrally with the stage base material so far described is only an example, and the same effect can be obtained by using other film forming means and joining means.

Next, with reference to FIG. 4, one example of feeding the electrode layer 52 will be shown. Feeding the electrode layer 52 is carried out as follows. That is, first, through holes are made in the stage base material 55 and the first insulating layer 62. Then, insulating pipes 70 for electric insulation are embedded therein. A conductive socket 71 is embedded in the tip of the pipe. The socket 71 is disposed such that its top is exposed in the upper surface of the first insulating layer 62, and the electrode layer 52 is formed by flame spraying tungsten onto it, which ensures the electric conductivity between the socket 71 and the electrode layer 52.

It becomes possible to feed the electrode layer 52 when a plug 72 is further mounted on a tip of a conductive cable and is inserted to an inlet of the socket 71 in an accommodating manner. With the above structure, the conductive cable 75 can easily be detached from and attached to the electrode layer 52. Therefore, the maintenance and assembly can be performed more easily and efficiently. In the present embodiment, only one feeding part is shown. However, when the electric power to be fed is greater, feeding may be carried out at two or more spots.

With use of the substrate stage 5 and the plasma processing apparatus equipped with the same so far described, cooling efficiency of the focus ring 51 can be dramatically improved. By keeping the absolute temperature of the focus ring 51 low, the influence of the heat radiated from the focus ring 51 to the wafer edge portion can be made small. When the plasma processing continues and the focus ring 51 is worn with a transit of time, in order to correct tilting at the wafer edge part, a bias voltage applied to the focus ring is raised. However, even if the temperature of the focus ring is raised slightly by an increase in the bias voltage, a control is performed to lower the absolute temperature of the focus ring. Therefore, the effect of heat radiation is suppressed and the rise in temperature at the wafer edge portion can be suppressed.

Furthermore, in the present embodiment, as described earlier, the temperature of the wafer 4 and the temperature of the focus ring 51 can be controlled independently. Thereby, the temperature of the focus ring 51 itself can be kept constant (within a predetermined range). That is, even if the focus ring 51 is worn, etching stop at the wafer edge portion and mask clogging can be suppressed over a long period of time. Further, a fall in yield rate at the wafer edge portion can be suppressed over a long period of time. Furthermore, by lowering the temperature of the focus ring itself, wearing rate of the focus ring can be lowered. Thus, a wet period can be made longer, and improvement in the operating ratio of the apparatus can be expected.

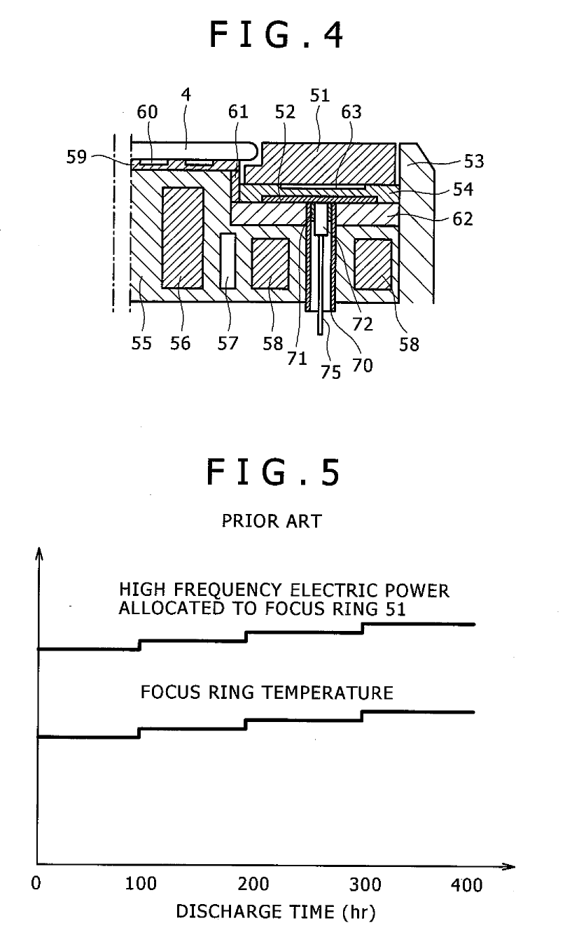

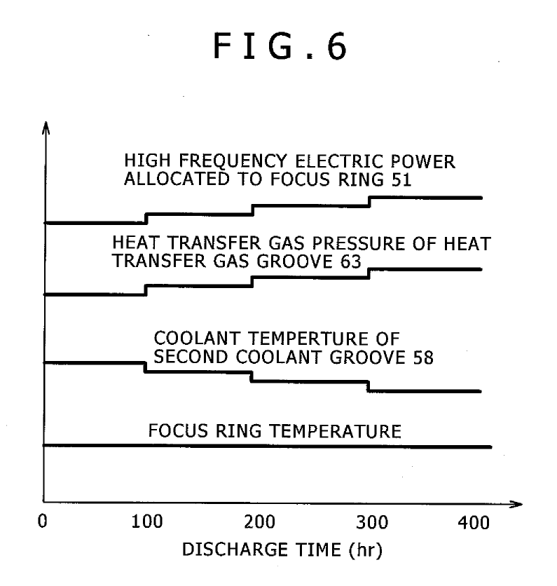

Now, with reference to a sequence diagram of the temperature of the focus ring and the high frequency bias electric power to be allocated as to an electric discharge time (application time of the high frequency bias electric power to the focus ring 51) without the measure of the present embodiment shown in FIG. 5 and with reference to a sequence diagram of the temperature of the focus ring, high frequency bias electric power, pressure of the heat transfer gas and the coolant temperature as to the electric discharge time (application time of the high frequency bias electric power to the focus ring 51) in the present embodiment shown in FIG. 6, workings will be described.

When the wafer processing is repeated and the high frequency bias electric power is applied to the focus ring 51 for a long time (for example, 100-hour unit), the focus ring 51 gets worn. In order to correct the tilting at the wafer edge portion caused by the wear, the bias voltage allocated to the focus ring 51 is raised (uppermost lines in FIGS. 5 and 6). In FIG. 5, the temperature of the focus ring 51 gradually rises as the bias voltage increases.

In FIG. 6 of the present embodiment, when the application time of the high frequency bias electric power to the focus ring 51 reaches a predetermined time (100 hours), by the command of the control means 201, the bias voltage to be allocated to the focus ring 51 is raised, the heat transfer gas pressure of the heat transfer gas groove 63 is increased, and the coolant temperature of the coolant groove 58 for the coolant flowing in the lower portion of the focus ring is lowered (all indicated my middle lines in FIG. 6). Thereby, when the heat transfer gas and the coolant absorb the temperature of the focus ring 51 being about to rise, the temperature of the focus ring 51 can be kept within a predetermined range (constant) (in FIG. 6, indicated by the lowest line).

Therefore, radiated heat from the focus ring 51 to the wafer edge does not vary. As a result, the variation over time in the temperature of the wafer edge portion can be suppressed, preventing the degradation in the etching characteristic of the wafer edge portion. In addition, when raising the bias voltage to be allocated to the focus ring 51, the high frequency bias power supply 11 is controlled by the command of the control means 201, and the whole bias power is raised to a predetermined value. The reason is to compensate the increase in the bias power to the focus ring, secure a predetermined value of the electric power applied to the substrate stage 5, and to maintain the etching characteristic.

Further, though not shown, by simply raising the pressure of the heat transfer gas in the lower portion of the focus ring alone and raising the heat transfer rate from the focus ring 51 to the outer periphery of the stage base material 55, a little but similar effect (minor adjustment) can be expected. Moreover, though not shown, simply by lowering the temperature alone of the coolant to be flowed into the second coolant groove 58, a little but similar effect can be expected.

Moreover, in FIG. 6, the high frequency bias electric power to be applied to the focus ring 51 and the coolant temperature are changed in a stepped manner. However, even when these are controlled smoothly in a linear manner, the same effect can be expected. Furthermore, though not shown, temperature monitor means, such as a fluorescent thermometer and a Pt sensor, may be installed inside the first insulating layer 62 or in the lower portion thereof, and feedback control according to the observed temperature may be performed. Needless to say, with such a structure, a more delicate temperature control is made possible.

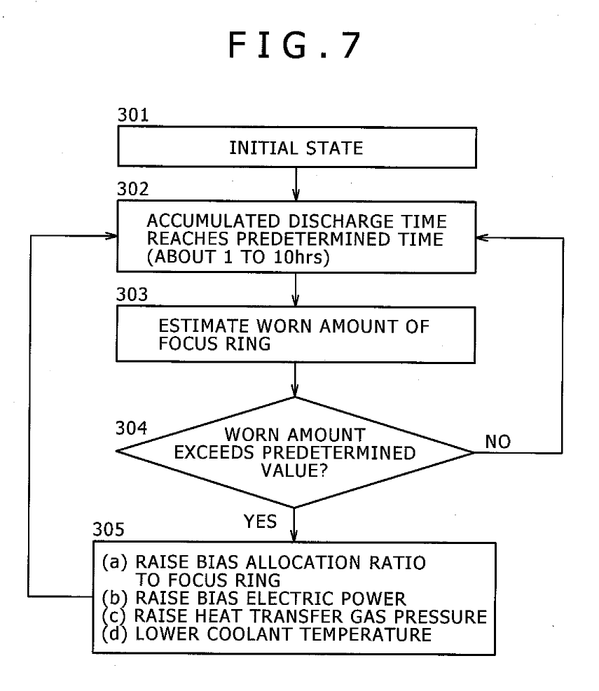

FIG. 7 is a flowchart showing the control operation by the control means 201 explained in FIG. 6.

After the accumulated discharge time (plasma processing time) in step 302 reaches a predetermined time from the initial state in step 301, a worn amount of the focus ring in step 303 is estimated. This is to cope with the case even where etching is performed on various conditions. The reason is that if etching is always performed on the same conditions, estimation of the worn amount of the focus ring is not necessary, but if the wearing rate of the focus ring may change according to different etching conditions. The estimation of worn amount of the focus ring is disclosed in the prior application, and can be attained by storing, in advance, the etching conditions and worn amount in a table.

The lapse of accumulated discharge time in step 302 is grasped by storing the application time of the high frequency bias electric power to the focus ring in the built-in storage means 201a of the control means 201. Subsequently, according to the stored application time, in steps 303 and 304, worn amount of the focus ring is estimated. When the amount exceeds a predetermined value, in step 305, the control means 201 issues various commands to control each part.

First, (a) the electric power allocation means 13 is controlled to raise the bias power ratio to the focus ring to a predetermined value. Next, (b) the high frequency bias power supply 11 is controlled to raise the whole bias power is to a predetermined value. This is for compensating an increase in the bias power to the focus ring, securing a predetermined value of the electric power to be applied to the substrate stage 5, and maintaining the etching characteristic. Subsequently, (c) according to the bias power allocated to the focus ring, the heat transfer gas introduction mechanism 23 is controlled to raise the heat transfer gas pressure in the heat transfer gas groove 63 to a predetermined value. Subsequently, (d) according to the bias power allocated to the focus ring, the temperature controller 22 is controlled to lower the coolant temperature of the second coolant groove 58 to a predetermined value.

The pressure of the heat transfer gas and the coolant temperature in the processes (c) and (d) are set to release portion of the temperature of the focus ring to go up. Therefore, the control is performed according to the bias power to be allocated to the focus ring, which is a ground of the portion of the temperature to be going up. In addition, if a sensor for detecting worn amount of the focus ring is used, a more highly accurate control can be performed.

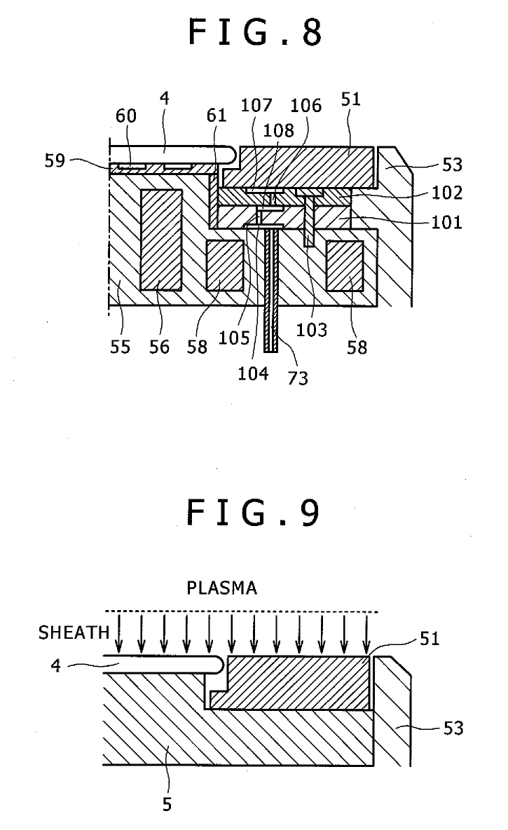

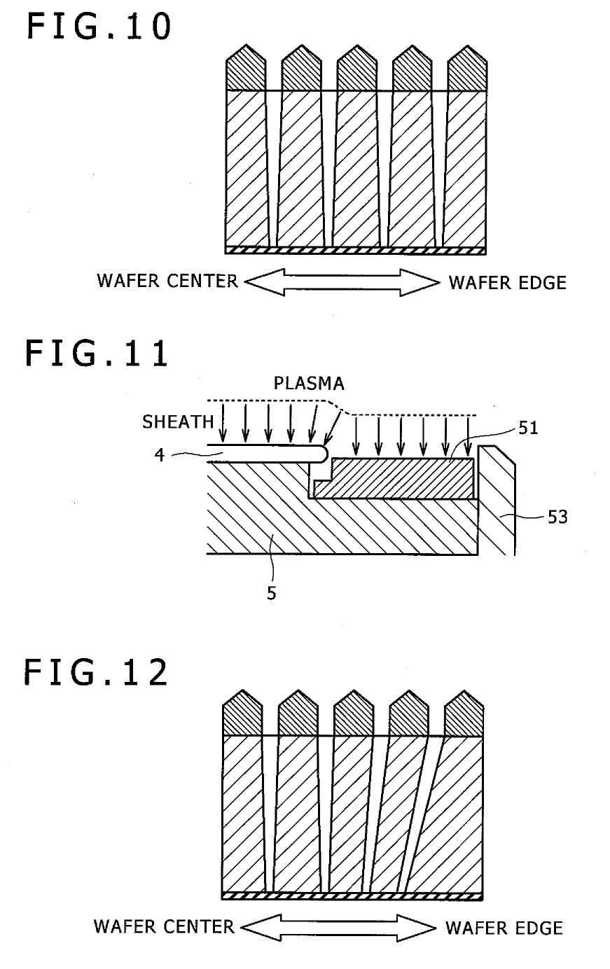

With reference to FIG. 8, a second embodiment of the present invention will be described. For the parts of this embodiment which already have been explained, an explanation thereof will be omitted. FIG. 8 is a cross section along a longitudinal direction of the outer periphery of the substrate stage according to the second embodiment of the present invention.

An electrode ring 102 and an insulating ring 101 are provided in the lower portion of the focus ring 51. A plurality of through holes are provided along a circumferential direction of the two rings, which are fastened to the outer periphery of the stage base material 55 with a plurality of insulating bolts 103. Also, a plurality of through holes are provided in the outer periphery of the stage base material 55. In the through holes, a plurality of heat transfer gas introduction tubes 73 made of alumina ceramics are inserted.

Heat transfer gas grooves 104 and 108, which are about 20 μm to 200 μm deep, are formed respectively in an undersurface and an upper surface of the insulating ring 101. The heat transfer gas introduced through the heat transfer gas introduction tube 73 passes along the gas groove 104 and uniformly spreads along a circumferential direction. Furthermore, heat transfer gas grooves 104 and 108 are connected by way of a plurality of through gas holes 105 whose inner diameters are about 0.2 mm to 2 mm. The heat transfer gas supplied into the gas groove 104 passes through the through gas hole 105 and spreads uniformly along the gas groove 108. Also, for the purpose of suppressing abnormal electric discharges in the gas hole and the gas groove, the heat transfer gas introduction tube 73 and the through gas hole 105 are arranged with a spatial relationship in which they cannot look toward each other.

The insulating ring 101 also serves to reduce high frequency coupling between the electrode ring 102 and the stage base material 55. Preferred materials for the insulating ring include aluminum nitride (AlN) and alumina (Al203), whose withstand voltages are high, heat transfer rates are comparatively high, and which do not cause contamination.

In the electrode ring 102, there are formed a plurality of through gas holes 106 having inner diameters from about 0.2 mm to 2 mm. Moreover, although not shown, on the upper surface of the electrode ring 102, an electrostatic chucking layer having a thickness of about 200 μm to 1000 μm is formed by flame spraying alumina or mixture of alumina/titania. Furthermore, a heat transfer gas groove 107 is formed in a surface of the electrostatic adsorption film. The heat transfer gas having spread through the heat transfer gas groove 108 formed in the upper surface of the insulating ring 101 further spreads uniformly in the heat transfer gas groove 107 by way of through gas holes 106 of the electrode ring. The through gas holes 106 and 105 are positioned with a spatial relationship in which they cannot look toward each other in order to suppress abnormal discharges in the gas hole and inside the gas groove.

To the electrode ring 102, in order to apply a high frequency bias to the focus ring 51, an output of the electric power allocation mechanism 13 (FIG. 1) is connected. Further, a DC power supply (not shown) for electrostatically chucking the focus ring 51 is connected. Preferred materials to form the electrode ring 102 include titanium, aluminum alloy, or conductive members made of low-resistant silicon, silicon carbide (SiC), etc. which do not cause contamination.

By applying a DC voltage from several hundreds of volts to several kilovolts to the electrode ring under a state where plasma is generated, the focus ring can be electrostatically chucked to the electrode ring. By introducing the heat transfer gas through the heat transfer gas introduction tubes in this state, the heat transfer gas spreads in a gap between an undersurface of the focus ring 51 and an upper surface of the electrode ring 102, a gap between an undersurface of the electrode ring and an upper surface of the insulating ring 101, a gap between an undersurface of the insulating ring and an upper surface of the stage base material 55, and in all the gaps, efficiently cooling the focus ring 51. As a result, the temperature of the focus ring, which might be 600° C. to 800° C. if not cooled, can be suppressed to 400° C. or lower. Thus, the influence of the heat radiated from the focus ring to the wafer edge can be reduced. As a result of this, it becomes possible to suppress the rise in the temperature at the wafer edge portion when the bias to be allocated to the focus ring is increased in order to suppress the tilting when the focus ring is worn. Thus, degradation of the etching characteristic at the wafer edge portion can be suppressed.

So far, embodiments of the substrate stage, plasma processing apparatus, and plasma processing method of the present invention have been described with reference to a plasma source of a parallel-plate type in which the upper electrode and the substrate stage are connected to respective high frequency power supplies. However, the scope of the present invention is not limited to the plasma source of a particular type. That is, the effects of the present invention can be achieved by combining with any of (1) a plasma source in which the upper electrode is connected to two or more power supplies, (2) a plasma source in which a lower electrode is connected to two or more power supplies, (3) a combination of (1) and (2), and a plasma source to which a control utilizing the magnetic fields is added.

What is claimed is:

1. A plasma processing apparatus, comprising: a vacuum vessel evacuated by vacuum evacuation means; gas supply means for supplying a gas to the vacuum vessel; a high frequency power supply for generating plasma; a substrate stage for loading a substrate to be processed and a focus ring disposed in the outer periphery of the substrate; a high frequency bias power supply for supplying a high frequency bias electric power to said substrate stage; and electric power allocation means for allocating and applying part of the high frequency bias electric power outputted from said high frequency bias power supply to the focus ring,
wherein there are formed in said substrate stage a heat transfer gas groove for introducing a heat transfer gas into a undersurface of said focus ring and a coolant groove for allowing a coolant to flow thereunder; and
wherein there are provided a storage medium for holding an application time of the high frequency bias electric power applied to said focus ring and control means for controlling, according to the stored application time, said electric power allocation means so as to change allocation of the high frequency electric power to the focus ring and, at the same time, controlling at least one of a pressure of said heat transfer gas and a temperature of said coolant.

2. The plasma processing apparatus according to claim 1, wherein an electrostatic chucking layer is formed integrally with an electrode layer and an insulating layer in a lower portion of said focus ring; and wherein said heat transfer gas groove is formed between said electrostatic chucking layer and the focus ring.

3. The plasma processing apparatus according to claim 1, wherein there are provided an electrode ring in the lower portion of said focus ring and an insulating ring in a lower portion thereof; wherein an electrostatic chucking layer is formed on an upper surface of said insulating ring by flame spraying; and wherein heat transfer gases are provided between an undersurface of said focus ring and an upper surface of said electrostatic chucking layer, between an undersurface of said electrode ring and the upper surface of said insulating ring, and between an undersurface of said insulating ring and an upper surface of the outer periphery of a base material of the substrate stage, respectively.

4. The plasma processing apparatus according to claim 1, wherein said control means controls the pressure of the heat transfer gas according to the electric power allocated to said focus ring.

5. The plasma processing apparatus according to claim 2, wherein said control means controls the pressure of the heat transfer gas according to the electric power allocated to said focus ring.

6. The plasma processing apparatus according to claim 3, wherein said control means controls the pressure of the heat transfer gas according to the electric power allocated to said focus ring.

7. The plasma processing apparatus according to claim 1, wherein said control means controls the temperature of a coolant to be allowed to flow in a lower portion of said focus ring according to the electric power allocated to said focus ring.

8. The plasma processing apparatus according to claim 2, wherein said control means controls the temperature of a coolant to be allowed to flow in the lower portion of said focus ring according to the electric power allocated to said focus ring.

9. The plasma processing apparatus according to claim 3, wherein said control means controls the temperature of a coolant to be allowed to flow in the lower portion of said focus ring according to the electric power allocated to said focus ring.

10. The plasma processing apparatus according to claim 1, wherein said control means controls the pressure of the heat transfer gas and the temperature of a coolant to be allowed to flow in the lower portion of the focus ring according to the electric power allocated to said focus ring.

11. The plasma processing apparatus according to claim 2, wherein said control means controls the pressure of the heat transfer gas and the temperature of a coolant to be allowed to flow in the lower portion of the focus ring according to the electric power allocated to said focus ring.

12. The plasma processing apparatus according to claim 3, wherein said control means controls the pressure of the heat transfer gas and the temperature of a coolant to be allowed to flow in the lower portion of the focus ring according to the electric power allocated to said focus ring.

13. A plasma processing method for processing, through the effect of plasma, a substrate to be processed placed on a substrate stage by supplying a gas to a vacuum vessel,
wherein a high frequency bias power supply applies, to said substrate stage, a predetermined high frequency bias electric power being different from a high frequency electric power supply for generating plasma;
wherein the electric power allocation means allocates and applies a high frequency bias electric power outputted from said high frequency bias power supply to a focus ring disposed in the periphery of said substrate to be processed;
wherein, according to an application time of the high frequency bias electric power to said focus ring by said plasma processing, the high frequency bias electric power to be applied to said focus ring is varied by controlling said electric power allocation means;
wherein said high frequency bias electric power to be applied to said substrate stage is controlled by controlling output of said high frequency bias power supply; and
wherein the temperature of said focus ring is controlled to be a predetermined temperature according to the high frequency bias electric power applied to said focus ring.
